(19) United States
(12) Patent Application Publication
(10) Pub. No.: US 2017/0091882 A1
(43) Pub. Date: Mar. 30, 2017

(54) AUTOMATIC GENERATION OF A PARTY MENU

(71) Applicant: INTERNATIONAL BUSINESS MACHINES CORPORATION, Armonk, NY (US)

(72) Inventors: JOHN CANALE, HOPEWELL JUNCTION, NY (US); THERESA S. DOWDEN, RED HOOK, NY (US); GREGORY L. DUNLAP, HIGHLAND, NY (US); PATRICK J. FADDEN, POUGHKEEPSIE, NY (US); JOHN A. STAUBI, RED HOOK, NY (US); ROBERT G. URFER, NEWTOWN, CT (US)

(21) Appl. No.: 15/178,678

(22) Filed: Jun. 10, 2016

Related U.S. Application Data
(63) Continuation of application No. 14/867,129, filed on Sep. 28, 2015.

(51) Int. Cl. G06Q 50/12; G06Q 10/10; G06Q 50/00

(52) U.S. Cl. CPC G06Q 50/12; G06Q 50/01; G06Q 10/1095

(57) ABSTRACT

Embodiments include method, systems and computer program products for automated menu planning for an event via a social network. Aspects include receiving a request for an event from a host via the social network and identifying a plurality of attendees for the event and one or more of a food preference and a food restriction for one or more of the plurality of attendees. Aspects further include determining a menu for the event based on the one or more of the food preference and the food restriction for the one or more of the plurality of attendees, wherein the menu includes a general set of constraints on a type of food that can be served at the event that will meet the food preference and the food restriction for the one or more of the plurality of attendees.

### DOMESTIC PRIORITY

This application is a continuation of the legally related U.S. application Ser. No. 14/867,129 filed Sep. 28, 2015, which is fully incorporated herein by reference.

### BACKGROUND

The present disclosure relates to social networks and more specifically, to methods, systems and computer program products for generating a menu for a party based on attendees food preferences and restrictions.

Recently, social networks have become an increasingly popular way for people to communicate with each other. One common use of social networks is for users to plan social events such as parties, meeting and the like. The social network is often used to send out invitations and to track who will be attending the event. In many cases, the host of the event will provide food for the attendees for the event.

Everyone has their own set of food preferences, food that they prefer, and food restrictions, foods that they cannot eat. These food preferences and restrictions may be based on health concerns, such as food allergies, a dietary preference, such as low calorie or vegetarian, religious constraints, such as only kosher foods, or the like. In many cases, the food preferences and restrictions of the individuals attending an event may not be known to the host of an event, which can make it difficult for a host to adequately plan a menu for the event.

### SUMMARY

In accordance with an embodiment, a method for automated menu planning for an event via a social network is provided. The method includes receiving a request for an event from a host via the social network and identifying a plurality of attendees for the event and one or more of a food preference and a food restriction for one or more of the plurality of attendees. The method also includes determining a menu for the event based on the one or more of the food preference and the food restriction for the one or more of the plurality of attendees, wherein the menu includes a general set of constraints on a type of food that can be served at the event that will meet the food preference and the food restriction for the one or more of the plurality of attendees.

In accordance with another embodiment, a system for automated menu planning for an event via a social network a processor in communication with one or more types of memory. The processor is configured to receive a request for an event from a host via the social network and identify a plurality of attendees for the event and one or more of a food preference and a food restriction for one or more of the plurality of attendees. The processor is also configured to determine a menu for the event based on the one or more of the food preference and the food restriction for the one or more of the plurality of attendees, wherein the menu includes a general set of constraints on a type of food that can be served at the event that will meet the food preference and the food restriction for the one or more of the plurality of attendees.

In accordance with a further embodiment, a computer program product for automated menu planning for an event via a social network includes a non-transitory storage medium readable by a processing circuit and storing instructions for execution by the processing circuit for performing a method. The method includes receiving a request for an event from a host via the social network and identifying a plurality of attendees for the event and one or more of a food preference and a food restriction for one or more of the plurality of attendees. The method also includes determining a menu for the event based on the one or more of the food preference and the food restriction for the one or more of the plurality of attendees, wherein the menu includes a general set of constraints on a type of food that can be served at the event that will meet the food preference and the food restriction for the one or more of the plurality of attendees.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram illustrating one example of a processing system for practice of the teachings herein;

FIG. 2 is a block diagram illustrating a social network in accordance with an exemplary embodiment;

FIG. 3 is a flow diagram of a method for automated menu planning for an event via a social network in accordance with an exemplary embodiment; and

FIG. 4 is a flow diagram of a method for automated planning of a venue for an event via a social network in accordance with an exemplary embodiment.

### DETAILED DESCRIPTION

In accordance with exemplary embodiments of the disclosure, methods, systems and computer program products for automated menu planning for an event via a social network are provided. In exemplary embodiments, a host of an event utilizes a social network application to invite multiple individuals to an event. The social network application will identify the individuals that are planning on attending the event and will automatically generate a menu for the event for the host. In exemplary embodiments, the menu created may include a general set of constraints on the types of food that the host can serve that will meet the food preferences and restrictions of the guests in attendance. In exemplary embodiments, the social network application is configured to keep the food preferences and restrictions of each individual private and does not separately provide the food preferences and restrictions for each individual guest to the host of the event. Rather, the social network application may provide a consolidated list of all of the food preferences and restrictions the guests that will attend the event.

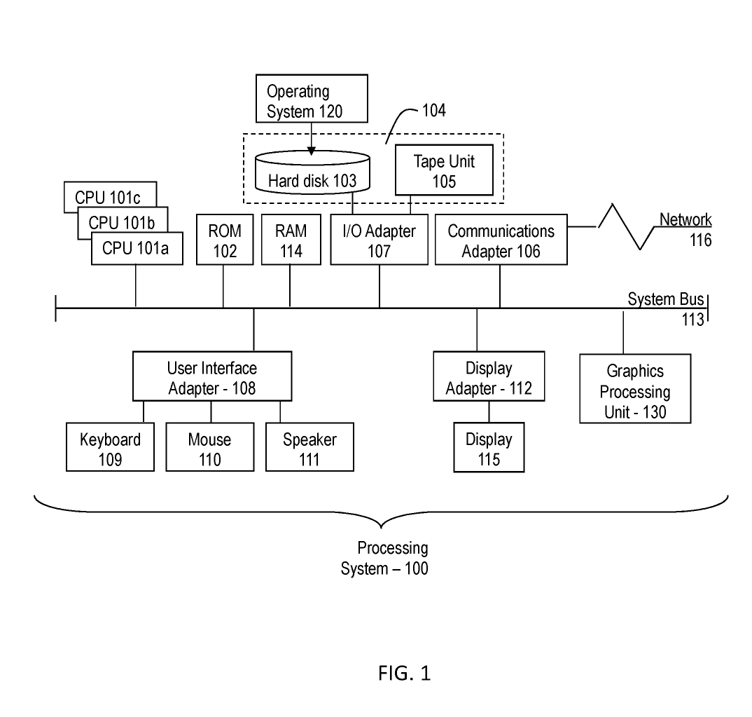

Referring to FIG. 1, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing, and has a highly parallel structure that makes it more effective than general-purpose CPUs for algorithms where processing of large blocks of data is done in parallel.

Thus, as configured in FIG. 1, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system such as the AIX® operating system from IBM Corporation to coordinate the functions of the various components shown in FIG. 1.

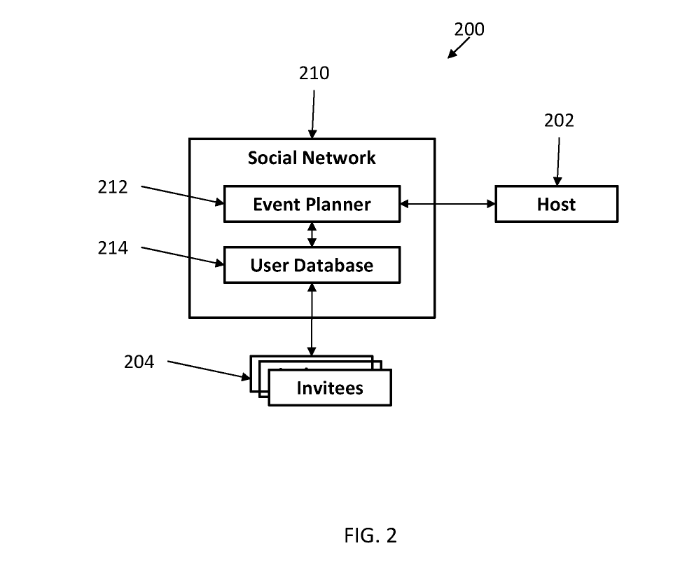

Referring now to FIG. 2, a system 200 including a social network application 210 in accordance with an embodiment is illustrated. As illustrated, the system 200 includes a social network application 210, a plurality of invitees 204 and a host 202. The social network application 210 includes a user database 214 configured to store the food preferences and restrictions of each of the users of the social network application 210. The social network application 210 also includes an event planner 212 that is configured to track the events organized by the host 202 and which invitees 204 will be attending each event. In exemplary embodiments, the event planner 212 will identify the invitees 204 that are planning on attending the event and will automatically generate a menu for the event for the host 202. In exemplary embodiments, the menu created may include a general set of constraints on the types of food that the host 202 can serve that will meet the food preferences and restrictions of the invitees 204 in attendance. In exemplary embodiments, the social network application 210 is configured to keep the food preferences and restrictions of each invitee 204 private and does not separately provide the food preferences and restrictions for each invitee to the host 202 of the event. Rather, the social network application 210 may provide a consolidated list of all of the food preferences and restrictions the invitee 204 that will attend the event to the host 202.

In exemplary embodiments, the social network application 210 may receive the food preferences and restrictions of the users of the social network application 210 during a user registration with the social network application 210. For example, when a user signs up for an account with the social network the user may be prompted to enter any food allergies, religious based food restrictions, taste or diet based food preferences or restrictions. In exemplary embodiments, the social network application 210 may be configured such that each of the user profiles are stored in an anonymous fashion such that the social network application 210 is not aware of the preferences of each user. In other embodiments, the user profiles may be stored locally by the users and may only be accessed with the user's permission.

In exemplary embodiments, the social network application 210 may be configured to identify the food preferences and restrictions of the users of the social network application 210 by data mining the social network activity of the user. For example, the social network application 210 may be configured to determine a likely religion, and therefore religious based food restrictions, of the user based on the user checking in at certain religious sites, liking certain posts, following specific users, or the like. In another example, the social network application 210 may be configured to determine a likely food preference based on a history of the restaurants that a user has checked in at, liked or followed, or previously attended events at. In a further example, the social network application 210 may be configured to determine a likely food preference based on comments or photos that a user has posted to the social network. In exemplary embodiments, the social network application 210 may be configured to use a combination of data mining and explicit user input in determining the food preferences and restrictions of the users of the social network application 210.

In exemplary embodiments, the menu created by the social network application 210 may include a general set of constraints on the types of food that the host 202 can serve that will meet the food preferences and restrictions of the invitees 204 in attendance. In exemplary embodiments, the types of food that the host 202 can serve may also be based on a planned location, time of day and time of year of the event. For example, the social network application 210 may suggest a different menu for a breakfast, lunch, or diner time meeting. In addition, the menu items may vary based on a geographical location or season of the year in which the event will take place. In exemplary embodiments, the host may provide some additional restraints such as budget, or food options that the social network application 210 may take into consideration when creating a menu.

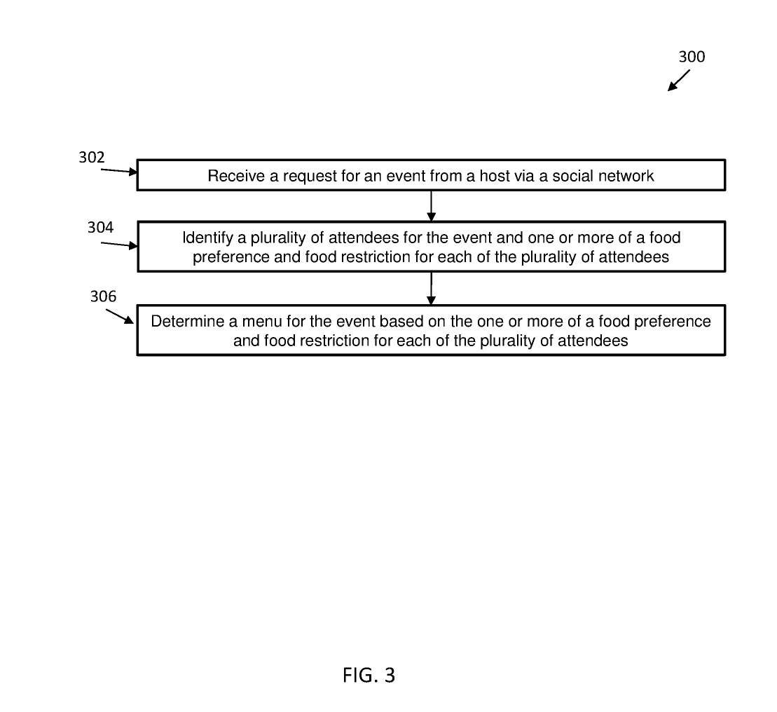

Referring now to FIG. 3, a flow diagram of a method 300 for automated menu planning for an event via a social network in accordance with an exemplary embodiment is shown. As shown at block 302, the method 300 includes receiving a request for an event from a host via a social network. In exemplary embodiments, the request includes one or more of a plurality of invitees for the event, a location of the event, a time and date of the event and a nature of the event. Next, the method 300 includes identifying a plurality of attendees for the event and one or more of a food preference and food restriction for each of the plurality of attendees, as shown at block 304. In exemplary embodiments, the plurality of attendees is identified by receiving positive responses to invitations to the event, which were generated by the social network in response to the request. In exemplary embodiments, the one or more of a food preference and food restriction for each of the plurality of attendees are identified based on a user profile for each of the plurality of attendees. The user profile may contain information that has been directly provided by users of the social network and/or information that has been data mined for the individual based on the user's interaction with the social network. Next, as shown at block 306, the method 300 includes determining a menu for the event based on the one or more of a food preference and food restriction for each of the plurality of attendees. In exemplary embodiments, the menu created may include a general set of constraints on the types of food that the host can serve that will meet the food preferences and restrictions of the guests in attendance. The general set of constraints on the types of food that the host can serve that will meet the food preferences and restrictions of the guests in attendance may also generally include a venue of an event.

In exemplary embodiments, the host of an event may desire to host the event at an undetermined venue and the social network application may be configured to identify possible locations for the event based on the number of attendees, the food preferences and restrictions of the attendees, and geographic and budget constraints provided by the host.

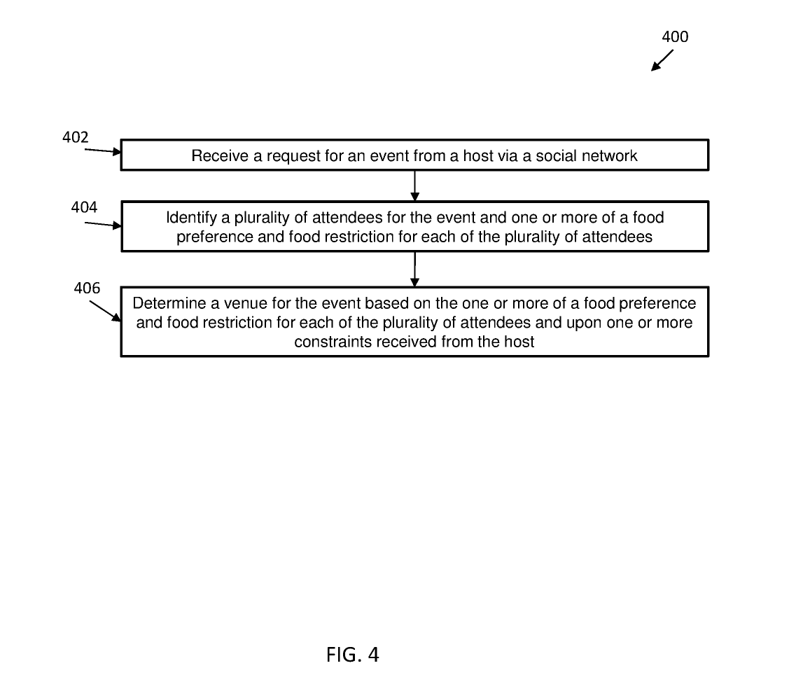

Referring now to FIG. 4, a flow diagram of a method 400 for automated planning a venue for an event via a social network in accordance with an exemplary embodiment is shown. As shown at block 402, the method 400 includes receiving a request for an event from a host via a social network. In exemplary embodiments, the request includes one or more of a plurality of invitees for the event, a location constraint for the event, other host constraints, a time and date of the event, and a nature of the event. For example, the host may provide a general geographic area that they want to host the event in, such as a zip code, a city or a specific geographic location and a maximum distance from the specific geographic location.

Next, the method 400 includes identifying a plurality of attendees for the event and one or more of a food preference and food restriction for each of the plurality of attendees, as shown at block 404. In exemplary embodiments, the plurality of attendees is identified by receiving positive responses to invitations to the event, which were generated by the social network in response to the request. In exemplary embodiments, the one or more of a food preference and food restriction for each of the plurality of attendees are identified based on a user profile for each of the plurality of attendees. Next, as shown at block 406, the method 400 includes determining a venue for the event based on the one or more of a food preference and food restriction for each of the plurality of attendees and upon the location constraint.

In exemplary embodiments, determining a venue for the event can be further based on additional constraints received from the host. Such constraints may include venue types, budget, and the like. In exemplary embodiments, determining a venue for the event includes interfacing with an online restaurant-reservation service that can provide the available food types and prices for a variety of restaurants and can provide other information regarding the restaurants such as ability to accommodate a party of the size needed, parking availability, group discounts or specials, availability of private party space and the like.

In exemplary embodiments, users of the social network can control the amount of information regarding their food preference and food restrictions that they wish to share with other users of the social network. For example, a user may select to anomalously share the information regarding their food preference and food restrictions to event hosts when the user indicates that they will attend an event organized by the host. In another example, the user may select to share the information regarding their food preference and food restrictions to event hosts when the user indicates that they will attend an event organized by the host, without obscuring the identity of the user.

Although the automated menu planning for an event via a social network is discussed above with reference to food items, it will be appreciated by those of ordinary skill in the art the methods and systems described herein may be used for other items of an event, such as the planning of beverages i.e., beer, wine, liquor, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field- programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for automated menu planning for an event via a social network, the method comprising:
receiving, by a processor, a request for an event from a host via the social network, wherein the request includes a plurality of invitees for the event, a location of the event, a time and a date of the event and a nature of the event;
identifying a plurality of attendees for the event and one or more of a food preference and a food restriction for one or more of the plurality of attendees, wherein the plurality of attendees are identified by receiving positive responses to invitations to the event, which were generated by the social network in response to the request; and
determining a menu for the event based on the one or more of the food preference and the food restriction for the one or more of the plurality of attendees, wherein the menu includes a general set of constraints on a type of food that can be served at the event that will meet the food preference and the food restriction for the one or more of the plurality of attendees,
wherein the one or more of the food preference and the food restriction for the one or more of the plurality of attendees are identified based on a user profile for each of the one or more of the plurality of attendees, wherein the user profile contains information that has been directly provided by users of the social network and information that has been data mined for the users of the social network based on the user's interaction with the social network, and
wherein social network is configured to keep the one or more of the food preference and the food restriction for the one or more of the plurality of attendees private and does not provide the one or more of the food preference and the food restriction for the one or more of the plurality of attendees to the host of the event.
